(19) United States
(12) Patent Application Publication
(10) Pub. No.: US 2026/0269894 A1
(43) Pub. Date: Sep. 10, 2026

(54) ANTENNA SWITCH DIVERSITY

(71) Applicant: QUALCOMM Incorporated, San Diego, CA (US)

(72) Inventors: Thawatt GOPAL, San Diego, CA (US); Dimeng WANG, Shanghai (CN); Kamalakar GANTI, San Marcos, CA (US); Sridhar BANDARU, Westminster, CO (US)

(21) Appl. No.: 19/158,005

(22) PCT Filed: Apr. 17, 2023
(86) PCT No.: PCT/CN2023/088631

§ 371 Date: Aug. 19, 2025

(51) Int. Cl. H04B 7/06; H04B 7/024; H04B 7/0413

(52) U.S. Cl. CPC H04B 7/0608; H04B 7/024; H04B 7/0413; H04B 7/0634

(57) ABSTRACT

Certain aspects of the present disclosure provide techniques for exclusion of antenna combinations for antenna switch diversity (ASDIV). An example method, performed at a wireless node, includes obtaining metrics for a set of candidate radio frequency (RF) path combinations to be considered for transmit antenna switch diversity (ASDIV), and removing at least a first RF path combination from the set when a condition involving at least one of the metrics is met.

### BACKGROUND

### Field of the Disclosure

Aspects of the present disclosure relate to wireless communications, and more particularly, to techniques for exclusion of antenna combinations for antenna switch diversity (ASDIV).

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication at a wireless node. The method includes obtaining metrics for a set of candidate radio frequency (RF) path combinations to be considered for transmit antenna switch diversity (ASDIV); and removing at least a first RF path combination from the set when a condition involving at least one of the metrics is met.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIG. 4 depicts an example of components capable of enabling antenna switch diversity (ASDIV).

FIG. 5 depicts another example of components capable of enabling ASDIV.

FIG. 6 depicts an example table illustrating ASDIV states and corresponding performance.

FIG. 7 depicts a call flow diagram, illustrating techniques for exclusion of antenna combinations for ASDIV, in accordance with certain aspects of the present disclosure.

FIG. 8 depicts a flow diagram illustrating techniques for a UE in a test mode, in accordance with certain aspects of the present disclosure.

FIG. 9 depicts a flow diagram illustrating techniques for a UE in connected mode, in accordance with certain aspects of the present disclosure.

FIG. 10 depicts a method for wireless communications.

FIG. 11 depicts aspects of an example communications device.

### DETAILED DESCRIPTION

Aspects of the present disclosure provide apparatuses, methods, processing systems, and computer-readable mediums for exclusion of antenna combinations for antenna switch diversity (ASDIV).

ASDIV generally allows two or more antennas to form different input and output ports to establish different RF paths. For example, in multiple-input multiple-output (MIMO) or multi-transmission co-banded scenarios, ASDIV may allow a wireless node to simultaneously use two transmit antennas.

Unfortunately, performance on different antenna combinations may vary due to non-ideal isolation between the two transmission radio frequency (RF) front-end paths (e.g., RF paths) arising from various sources. In other words, the transmission/reception performance of different antenna path combinations may vary due to differences in isolation levels across antenna combinations. For example, in UL-MIMO antenna switch diversity (ASDIV) field testing, UL throughput may be degraded on UE transmission antenna path combinations with worse isolation.

This degradation may be confirmed, for example, via error vector magnitude (EVM) measurements. EVM generally refers to a metric used to quantify the combination of all signal impairments in systems that use digital modulation, which can be represented through a plot of in-phase (I) and quadrature (Q) vectors also known as a constellation diagram. In general, EVM is calculated as a root means square (rms) of error vector magnitudes between received symbol locations and their closest ideal constellation locations. Thus, EVM generally provides a measure of how accurately a wireless system is transmitting symbols within its constellation.

Current ASDIV algorithms may consider certain metrics, such as reference signal receive power (RSRP) and transmission power headroom deltas, across different individual antennas, but typically fail to consider metrics (such as EVM) across various antenna combinations, which may result in UL throughput loss.

Aspects of the present disclosure provide techniques that may allow for automatic (e.g., automated) exclusion of known antenna combinations/paths for ASDIV switching decisions. As a result, techniques presented herein may help avoid (UL and/or DL) throughput loss by avoiding known antenna combinations/paths with problematic isolation issues (e.g., as indicated by EVM measurements).

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

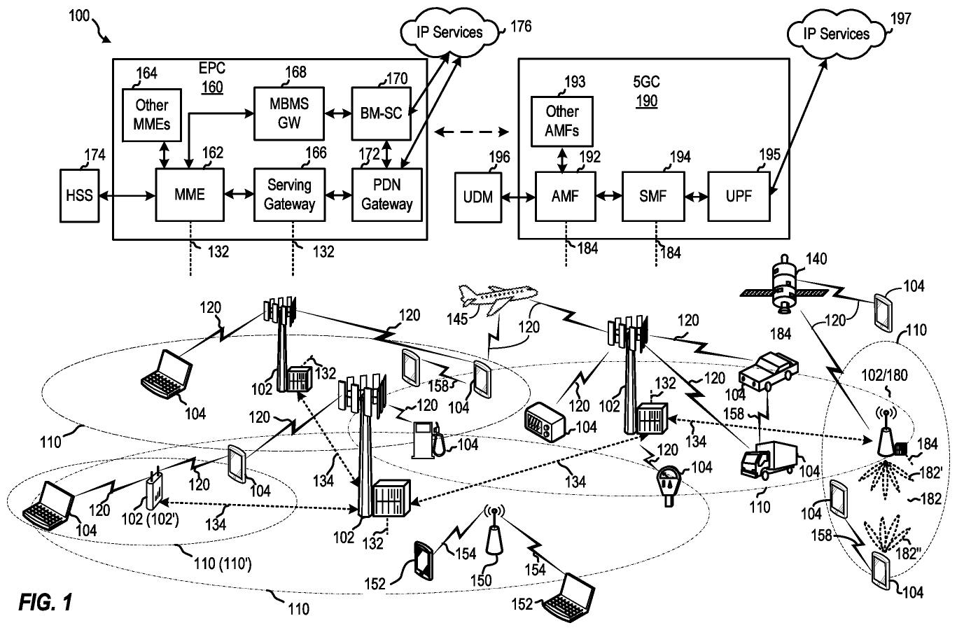

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IOT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

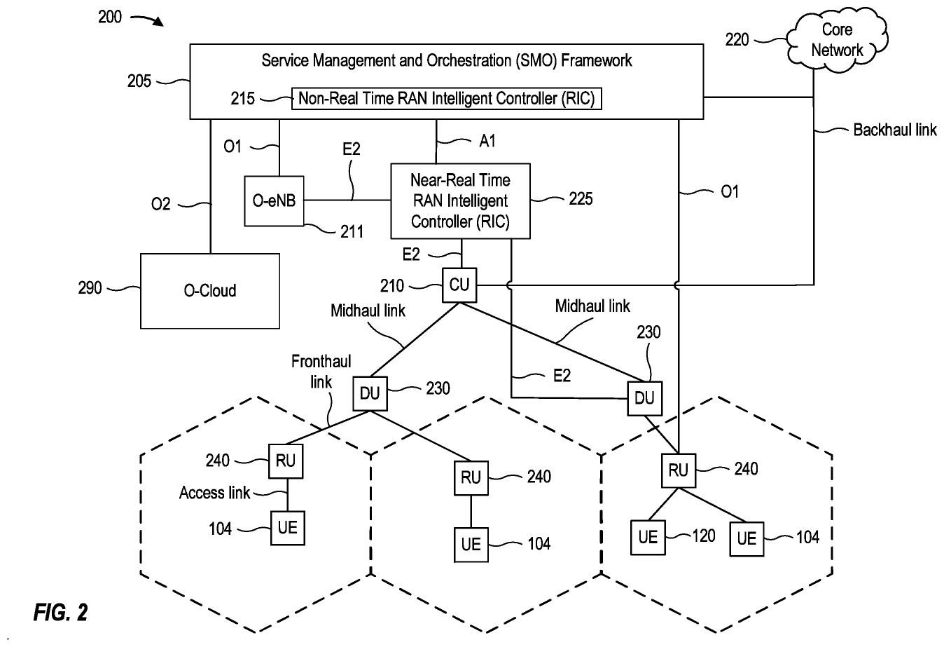

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mm Wave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the El interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an Ol interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an Al interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as AI policies).

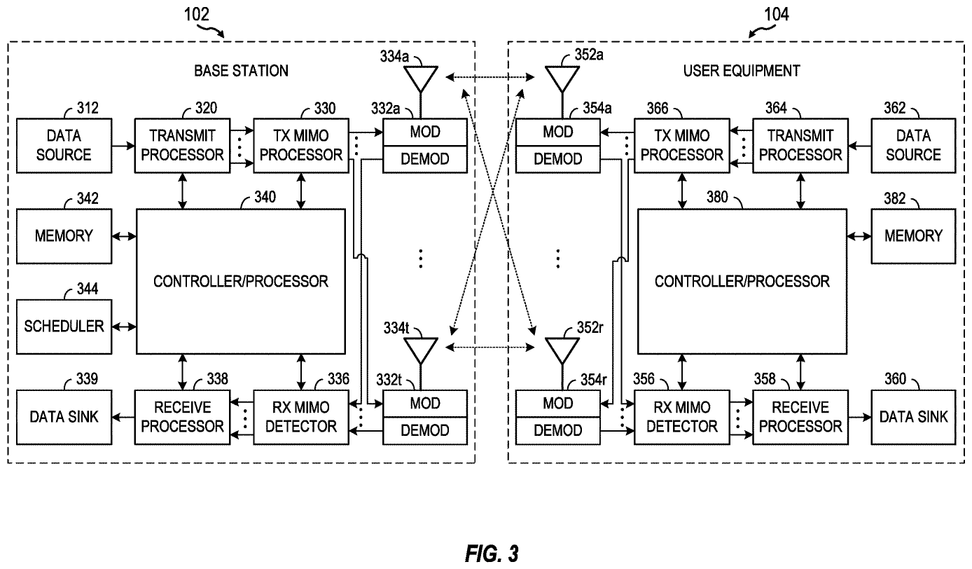

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

### Example Antenna Switch Diversity (ASDIV) and Radio Frequency (RF) Paths

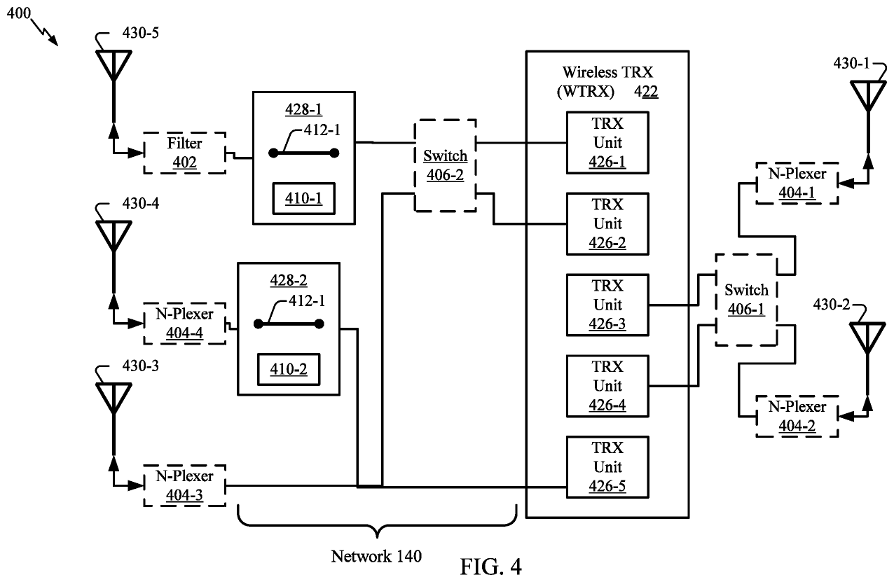

FIG. 4 illustrates a portion of an electronic device 400 having multiple antennas operating with multiple wireless protocols and including a first and second switched filter, in accordance with certain aspects of the present disclosure. The electronic device may be an example of the UE 104 of FIGS. 1 and 3. In addition to including the various components illustrated in FIG. 3, the electronic device 400 may further include the one or more components shown in FIG. 4. For example, the electronic device 400 may also include input/output ports (I/O ports) that enable data exchanges or interaction with other devices, networks, or users. The I/O ports may include serial ports (e.g., universal serial bus (USB) ports), parallel ports, audio ports, infrared (IR) ports, and so forth.

For communication purposes, the electronic device 400 also includes a wireless transceiver 422 coupled with a modem (not shown), a switched filter and controller 428, and one or more antennas 430-n. The wireless transceiver 422 provides connectivity to respective networks and other electronic devices connected therewith using radio-frequency (RF) wireless signals. Additionally or alternatively, the electronic device 400 may include a wired transceiver, such as an Ethernet or fiber optic interface for communicating over a personal or local network, an intranet, or the Internet.

The wireless transceiver 422 may facilitate communication over any suitable type of wireless network, such as a wireless local area network (LAN) (WLAN) such as Wi-Fi or Bluetooth (or an equivalent near-field communication network), a peer-to-peer (P2P) network, a mesh network, a cellular network, a wireless wide-area-network (WWAN) such as 3GPP 2 LTE or 5G NR, a navigational network (e.g., the Global Positioning System (GPS) of North America or another Satellite Positioning System (SPS)), and/or a wireless personal-area-network (WPAN). In the context of the example environment 100, the wireless transceiver 422 enables the electronic device 400 to communicate with the base station 104 and networks connected therewith. Other figures referenced herein may pertain to other wireless networks.

The modem of the electronic device 400, such as a baseband modem, may be implemented as a system on-chip (SoC) that provides a digital communication interface for data, voice, messaging, and other applications of the electronic device 400. The modem may also include baseband circuitry to perform high-rate sampling processes that can include analog-to-digital conversion (ADC), digital-to-analog conversion (DAC), gain correction, skew correction, frequency translation, and so forth. The modem may also include logic to perform in-phase/quadrature (I/Q) operations, such as synthesis, encoding, modulation, demodulation, and decoding. More generally, the modem may be realized as a digital signal processor (DSP) or a processor that is configured to perform signal processing to support communications via one or more networks. Alternatively, ADC or DAC operations may be performed by a separate component or another illustrated component, such as the wireless transceiver 422.

The wireless transceiver 422 can include circuitry, logic, and other hardware for transmitting or receiving a wireless signal for at least one communication frequency band. In operation, the wireless transceiver 422 can implement at least one radio-frequency transceiver unit to process data and/or signals associated with communicating data of the electronic device 400 via the antenna 430. Generally, the wireless transceiver 422 can include filters, switches, amplifiers, and so forth for routing and processing signals that are transmitted or received via the antenna 430. As shown, the wireless transceiver 422 includes at least one converter unit (e.g., for ADC or DAC operations) and at least one transceiver (TRX) unit 426. But generally, the wireless transceiver 422 includes multiple transceiver units (e.g., for different wireless protocols such as WLAN versus WWAN or for supporting different frequency bands or frequency band combinations).

In some cases, components of the wireless transceiver 422, or a transceiver unit 426 thereof, are implemented as separate receiver and transmitter entities. Additionally or alternatively, the wireless transceiver 422 can be realized using multiple or different sections to implement respective receiving and transmitting operations (e.g., using separate transmit and receive chains). Example implementations of a transceiver unit 426 are described below. Further, example implementations of a switched filter 428 and a switched filter controller, including interactions with the wireless transceiver 422 and the associated modem, are described herein. At least a portion of the switched filter controller may be implemented by the modem. In addition, different wireless protocols such as WWAN and WLAN may be implemented on separate chips or as separate SoCs. As such, the blocks such as the modem and transceiver 422 may represent more than one modem or transceiver implemented either together on separate chips or separate SoCs.

In some implementations, there may be communication signals transmitted either between different transceiver units or between different modem segments to alert each other about communication events. For example, there may be high speed GPIO pins between a WWAN transceiver unit 426-1 and WLAN transceiver unit 426-n that may be referred to as coexistence pins. When one transceiver unit 426-n is becoming operational (e.g., about to transmit or about to receive in order to establish a channel or for other purposes), the coexistence pin may be used to send a signal alerting the other transceiver unit 426-n. The switched filter controller may receive signals on the coexistence pins to determine whether to switch between the bypass signal path and the filtered signal path based on the signals (e.g., RF path switch or selection). In this case, the switched filter controller is configured to selectively connect the transceiver unit 426-1 to the antenna 430 via the bypass signal path or via the filtered signal path based further on a signal from a second transceiver unit 426-n indicating a transmission or reception associated with a rejection band of the filter 410. For example, based on a signal from the coexistence pin from the WLAN transceiver unit 426-n, the switched filter controller may determine to switch to the filtered signal path in order to ensure the WLAN transceiver unit 426-1 is free of interference when transmitting or receiving a preliminary communication for establishing a channel. The coexistence pin may be faster than messaging between modems, which may have some latency.

As such, in general, the wireless communications apparatus may include a second transceiver unit 426-n and the switched filter controller is configured to cause the switching circuitry 202 to selectively connect the transceiver unit 426-1 to the antenna 430 via the bypass signal path or via the filtered signal path based further on information from the second transceiver unit 426-n. The information from the second transceiver unit 426-1, among other parameters may include information indicative of an operational frequency band of a second signal different than the carrier signal, or a location of a center frequency of the second signal within the operational frequency band, or a power level of the second signal, or some combination thereof.

An electronic device may have more than one switched filter 428. FIG. 4 illustrates a portion of an electronic device 400 having multiple antennas operating with multiple wireless protocols. As shown in FIG. 4, the electronic device 400 includes multiple antennas 430, at least one filter 402, at least one N-plexer 404, at least one switch 406, and at least one wireless transceiver 422, in addition to a first switched filter 428-1 and a second switched filter 428-2. Optional elements are shown with dashed lines. These components are interconnected using multiple electrically-conductive lines (e.g., wires or traces). As illustrated, the electronic device includes five antennas 430-1, 430-2, 430-3, 430-4, and 430-5. However, an electronic device 400 may have more or fewer antennas. Each respective antenna 430 is optionally coupled to a respective filter 402 or N-plexer 404. Thus, five total filters or N-plexers are coupled to the five antennas 430-1 . . . 430-5. N-plexers can include diplexers, triplexers, and so forth. An N-plexer can enable multiband antenna sharing with other modules that operate in different bands (e.g., 800 MHz, mid band (such as 1700-2200 MHz), and 5 GHz). To do so, each N-plexer includes two or more filter units configured to attenuate frequencies that are to be blocked from further propagation. Thus, a triplexer may include a high pass filter unit (e.g., for 5150-5925 MHz), a band-pass filter unit (e.g., for 3400-3800 MHz), and a low-pass filter unit (e.g., for 1400-2680 MHz). Although not shown, a respective conductive line extends from each respective filter unit to another respective component, such as a switch 406 or transceiver unit 426.

Starting from the top right corner and moving clockwise, a first antenna 430-1 is coupled to a first N-plexer 404-1, and a second antenna 430-2 is coupled to a second N-plexer 404-2. A third antenna 430-3 is coupled to a third N-plexer 404-3, and a fourth antenna 430-4 is coupled to a fourth N-plexer 404-4. A fifth antenna 430-5 is optionally coupled to a filter 402. However, an electronic device may include fewer N-plexers or different number of filters or N-plexers, such as if an antenna 430 is associated with multiple filters or N-plexers. Here, each N-plexer 404 can be implemented using one or multiple filter units and corresponding filter paths extending from each filter unit. Each of the filter units can include, for example, a low pass filter, a high pass filter, or a bandpass filter.

The wireless transceiver 422 includes multiple transceiver units. Specifically, five transceiver units 426-1, 426-2, 426-3, 426-4, and 426-5 are shown. Each respective filter 402 or N-plexer 404 is coupled to at least one respective transceiver unit 426-1 to 426-5. Although five transceiver units 426-1 to 426-5 are shown, the wireless transceiver 422 can include a different number of transceiver units, such as if an antenna 430 and corresponding filter or N-plexer are coupled to more than one transceiver unit 426.

Thus, a network of conductive lines, additional filters or N-plexers, buffers, splitters, switches, and so forth can extend between the filter and N-plexers that are depicted and the multiple transceiver units 426-1 to 426-5 as indicated by network 412. Although the network 412 is only explicitly indicated “on the left” of the wireless transceiver 422, the network 412 may also include such components “on the right” of the wireless transceiver 422. Further, for clarity, additional details of this network 412 are omitted from FIG. 4. However, two switches are explicitly illustrated. A switch 406-1 is coupled between (i) the first N-plexer 404-1 and the second N-plexer 404-2 on one side and (ii) the third transceiver unit 426-3 and the fourth transceiver unit 426-4 on the other side. Also, a switch 406-2 is coupled between (i) the first switched filter 428 and the third N-plexer 404-3 on one side and (ii) the first transceiver unit 426-1 and the second transceiver unit 426-2 on the other side.

Different antennas can be useful for signal diversity, various signal frequencies, different communication technologies, implementing multiple-input multiple output (MIMO) processing for multiple streams, carrier aggregation (CA), beamforming from a particular side of an electronic device, and so forth.

As illustrated, the electronic device 400 includes a first switched filter 428-1 and a second switched filter 428-2. The first switched filter 428-1 is coupled between a first transceiver unit 426-1 and the fifth antenna 430-5. The second switched filter 428-2 is coupled between a fifth transceiver unit 426-5 and the fourth antenna 430-4. The different transceiver units 426-1 and 426-5 may be configured for different frequency bands (and/or different wireless protocols). Each switched filter 428-1 and 428-1 may operate similar to that described above, but each be configured with a filter 410 having a different frequency response (e.g., notch filters with different rejection bands). Each frequency response may be provided to selectively prevent interference with another band outside the band the respective transceiver unit 426 is operating.

As one example, the first transceiver unit 426-1 may be configured to transmit via a WWAN band (e.g., LTE B40 or NR N40) and the filter 410-1 in the first switched filter 428-1 may be configured with a rejection band covering a WLAN band (e.g., Wi-Fi 2.4 GHZ). In this example, the fifth transceiver unit 426-5 may be configured to transmit in another WWAN band (e.g., N79) and the filter 410-2 in the second switched filter 428-2 may be configured with a rejection band covering another WLAN band (e.g., Wi-Fi 5 GHz). Alternatively, the fifth transceiver unit 426-5 may be configured to transmit in a WLAN band (e.g., Wi-Fi 2.4 GHz) while the filter 410-2 in the second switched filter 428-2 may be configured with a rejection band covering a portion of a WWAN band (e.g., LTE B40 or NR N40). Other switched filters (not shown) may be provided as well for different coexistence scenarios.

In another example, a first transceiver unit 426-1 configured for the N79 band may have switched filter 428-1 with a filter 410-1 with a rejection band within a Wi-Fi band at 5 GHz. Likewise, a fifth transceiver unit 426-5 configured for 5 GHz Wi-Fi may have a switched filter 428-2 with a filter 410-2 that has a rejection band within N79 to avoid de-sensing receiving in the N79 band. A 2.4 GHz second harmonic may also de-sense receiving in the N79 band, so likewise a fifth transceiver unit 426-5 configured for 2 GHz Wi-Fi may have a switched filter 428-2 with a filter 410-2 that has a rejection band within the N79 band.

With reference to FIG. 4, in several scenarios above, the carrier signal is a transmitted signal via the transceiver unit 426-1 and the filter 410 protects an adjacent or other band different from the frequency band within which the carrier signal is operating. However, in other scenarios, the reverse may be true and the filter 410 may be provided to improve the ability to extract a receive signal received via the transceiver unit 426-1. For example, an LTE B40 or NR N40 receive signal may be saturated when in the adjacent 2.4 GHz band, Wi-Fi is transmitting and operating towards the upper end of the 2.4 GHz band. The switched filter controller may detect this scenario and cause the switching circuitry 202 to connect the antenna 430 to the transceiver unit 426-1 using the filtered signal path via the filter 410. This may increase the ability to receive the signal in the LTE B40 or NR N40 band. As LTE B40 or NR N40 may be operated in a time division duplexed (TDD) fashion, the switching circuitry 202 may be configured to toggle the one or more switches synchronously with the TDD cycle (e.g., if for LTE B40 or NR N40 transmission the switched filter is determined to use the bypass signal path but for LTE B40 or NR N40 reception the switched filter is determined to use the filtered signal path then the switching circuitry 202 may toggle the one or more switches synchronously with the TDD cycle between the bypass line 412 and the filter 410). Regardless, the switched filter 428 may be provided for different frequency bands in different scenarios for filtering for either a signal transmitted or received via the transceiver unit 426-1 connected to the switched filter or a signal passing through another transceiver unit 426-2.

### Aspects Related to Exclusion of Antenna Combinations for Asdiv

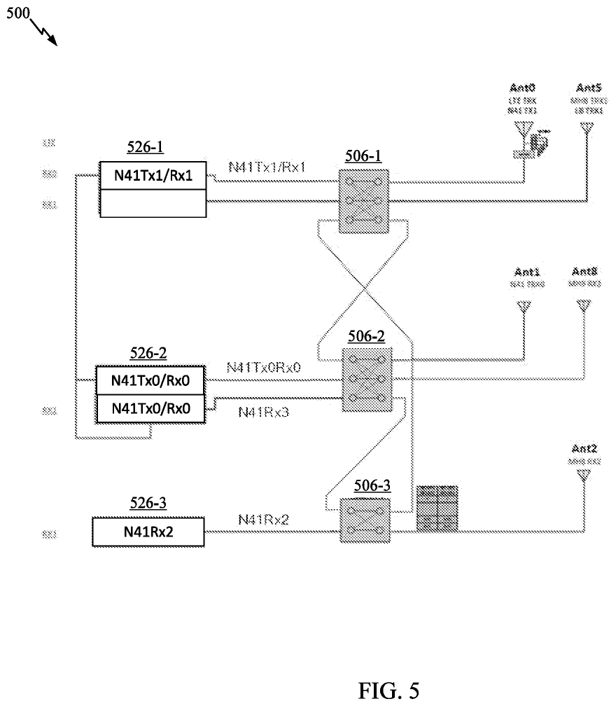

As noted above, with multiple antenna choices enabled by RF front-end antenna switches (e.g., such as in the example illustrated in FIG. 5 using cascaded antenna switches), transmission performance (e.g., of a wireless node, UE, or CPE) may vary due to differences in isolation levels across antenna combinations.

FIG. 5 illustrates a portion of an electronic device 500 having multiple antennas (e.g., which may be operating with multiple wireless protocols and/or operating modes), with cascaded antenna switches 506 (506-1, 506-2, and 506-3) to select antenna paths between antennas and transceiver (TRX) units 526 (526-1, 526-2, and 526-3).

As illustrated in FIG. 5, an RF path is formed between a selected antenna and TRX unit 526. The antenna/RF path may be enabled or disabled using switches 506. In some cases, multiple antennas (e.g., which make up an antenna combination, and correspond to an RF path combination) may be used simultaneously.

For example, assuming no limitations on an antenna cross-switches configuration, up to 6 antenna combinations are possible for a 4 antenna design using two transmission antennas simultaneously for UL-MIMO. Assuming the same constraints, up to 15 antenna combinations are possible for a 6 antenna design and up to 32 antenna combinations are possible for an 8 antenna design.

Unfortunately, performance on different antenna combinations may vary due to non-ideal isolation between the two transmission radio frequency (RF) front-end paths (e.g., RF paths) arising from various sources. In other words, the transmission/reception performance of different antenna path combinations may vary due to differences in isolation levels across antenna combinations. For example, in UL-MIMO antenna switch diversity (ASDIV) field testing, UL throughput may be degraded on UE transmission antenna path combinations with worse isolation.

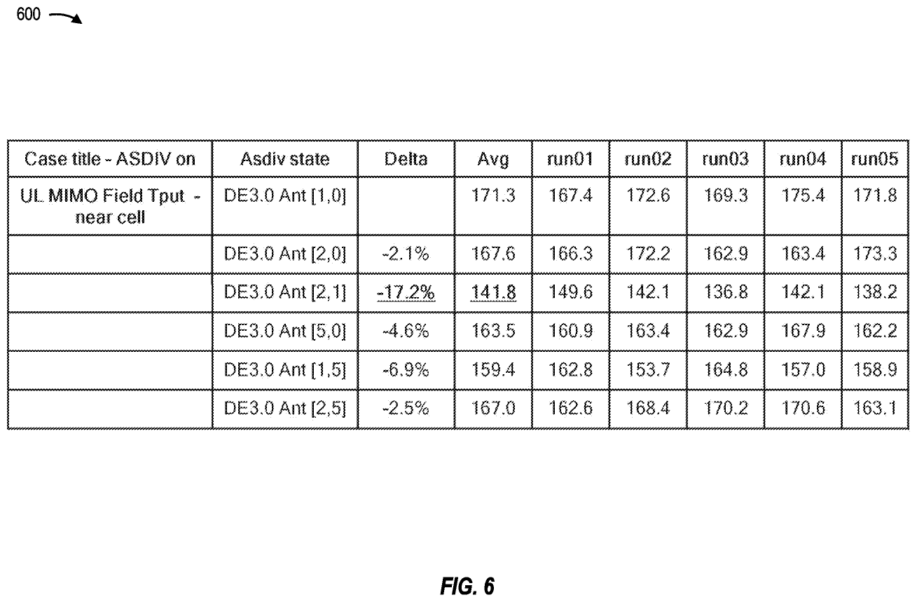

An example of this degradation is shown in table 600 of FIG. 6. The example shows UL MIMO throughput (Tput) for different combinations (pairs) of antennas shown in FIG. 5: (1,0), (2,0), (2,1), (5,0), (1,5), and (2,5). The table compares the average Tput of each combination, with a difference (Delta) relative to the combination with the highest Tput (antenna combination (1,0) has a Tput of 171.3 Mbps). As illustrated, antenna combination (2,1) has the lowest Tput (−17.2% lower than (1,0)). As such, this combination may be a candidate for exclusion using the techniques presented herein.

As noted above, in some cases, degradation may be confirmed, for example, via error vector magnitude (EVM) measurements. According to certain aspects EVM characteristics of different antenna combinations may be measured and used to determine what antenna combinations to include/remove in a set of candidate antenna combinations available for ASDIV.

Aspects of the present disclosure provide techniques that may allow for automatic (e.g., automated) exclusion of known antenna combinations/paths for ASDIV switching decisions. As a result, techniques presented herein may help avoid (UL and/or DL) throughput loss by avoiding known antenna combinations/paths with problematic isolation issues (e.g., as indicated by EVM measurements).

For example, referring again to FIG. 6, techniques presented herein may exclude the combination of antenna 1 and antenna 2, denoted Ant(2,1) from candidate antenna path combinations for ASDIV. These techniques described herein may be applicable for ASDIV operations at wireless nodes (e.g., UEs and customer premises equipment (CPE)). For example, in scenarios involving a CPE, the number of antenna combinations/paths may increase significantly (e.g. 8 or more antennas may be used), and the techniques proposed herein may help to exclude problematic combinations/paths automatically.

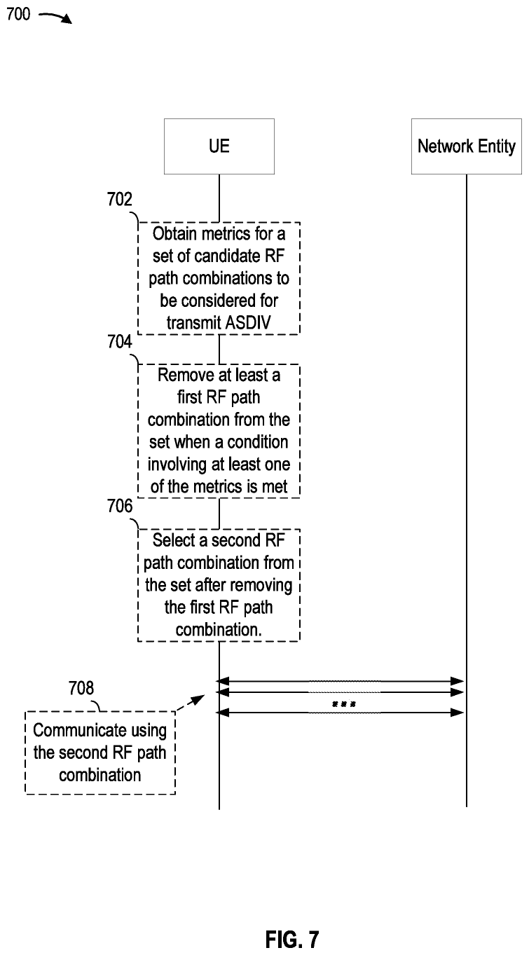

Techniques for exclusion of antenna combinations for ASDIV, in accordance with certain aspects of the present disclosure, may be understood with reference to the example call flow diagram 700 of FIG. 7 depicts a call flow diagram 700.

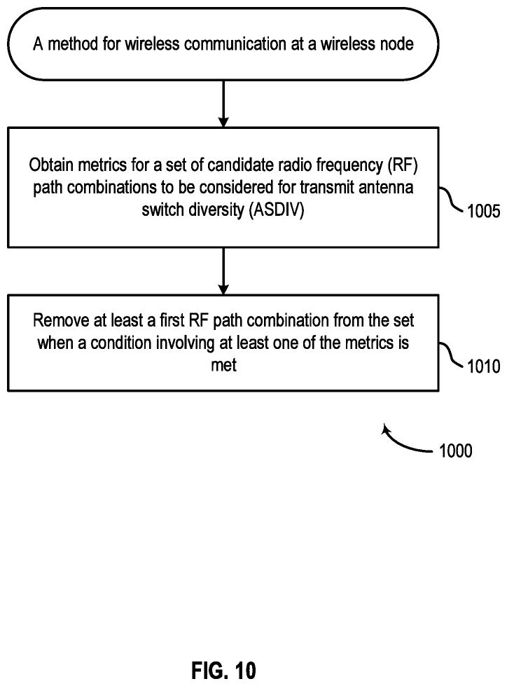

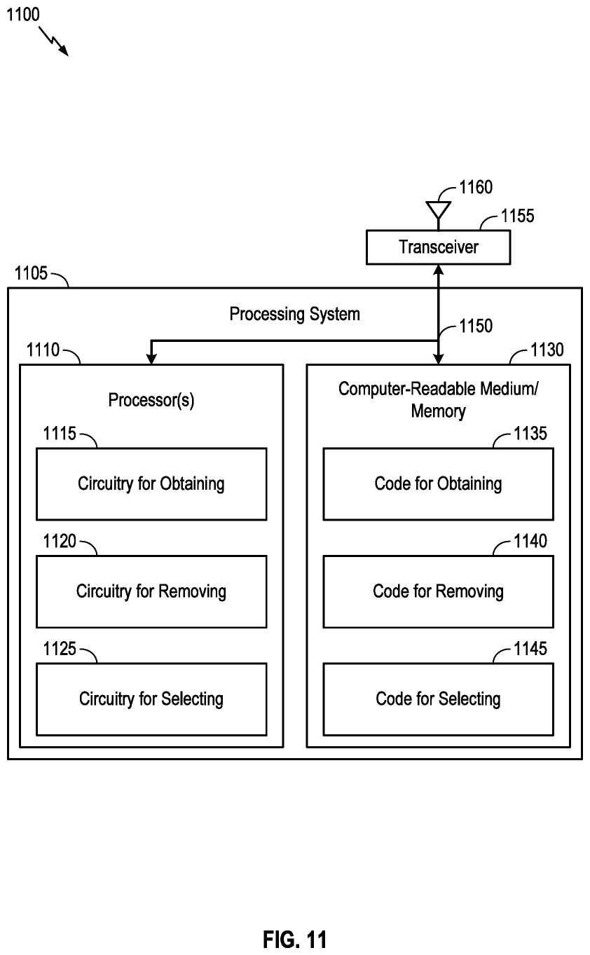

In some aspects, the UE shown in FIG. 7 may be an example of the UE 104 depicted and described with respect to FIGS. 1 and 3. In some aspects, the network entity shown in FIG. 10 (FIG. 11, and FIG. 12) may be an example of the BS 102 (e.g., a gNB) depicted and described with respect to FIGS. 1 and 3 or a disaggregated base station depicted and described with respect to FIG. 2.

As illustrated at 702, a UE (e.g., a wireless node or CPE) may obtain metrics for a set of candidate RF path combinations (e.g., which may correspond to a set of antenna combinations) to be considered for transmit ASDIV. In some aspects, the metrics may be obtained (e.g., retrieved) from memory (e.g., non-volatile memory) associated with the UE.

As will be described in greater detail below, the metrics may be obtained from operations conducted (e.g., with testing equipment/a test box) in a testing mode (e.g., a factory test mode (FTM). In some aspects, the metrics may comprise error vector magnitude (EVM) metrics or EVM measurements for the set of candidate RF path combinations. For example, in some cases, the EVM metrics may be measured while the UE is in a test mode and stored in memory at the UE. In some aspects, the EVM metrics may be measured for the set, for a configured transmission characteristic (e.g., a configured modulation and coding scheme (MCS) value).

As illustrated at 704, the UE may remove at least a first RF path combination (e.g., which may correspond to an antenna combination (two or more antennas)) from the set when a condition involving at least one of the metrics is met. In some aspects, the condition is met when the EVM metric measured for the at least the first RF path combination exceeds an EVM threshold. In some cases, the EVM threshold may be configured.

As illustrated at 706, the UE may select a second RF path combination from the set after removing the first RF path combination. In other words, the UE may select an antenna combination for communications based on a subset created by removing the at least the first RF path combination from the set.

As illustrated at 708, the UE may communicate with a network entity using the second RF path combination (e.g., which corresponds to an antenna combination).

In some cases, EVM measurements may be obtained a-priori in a controlled (and calibrated) environment, while the device is in a test mode (e.g., a factory test mode or FTM). This approach may be advantageous for original equipment manufacturers (OEMs), who have various industrial design constraints with respect to RF front-end layout and design topology.

As noted above, in some aspects, for wireless nodes (e.g., UEs or CPEs) which support UL-MIMO or UL carrier aggregation (CA) co-banded RF band/Absolute Radio Frequency Channel Number (ARFCN), EVM characterization may be performed in a test mode where a UE/CPE transmitter may be configured for a corresponding transmission power and ARFCN with a corresponding bandwidth/number of resource blocks (RBs), and MCS.

According to certain aspects of the present disclosure, testing equipment (e.g., a test-box) may be used to measure EVM across (all) possible antenna and antenna path combinations. The EVM measurements may then be stored (e.g., in non-volatile memory that can be accessed by a UE/CPE/modem), and provide the measurements back to the UE when operating in a connected mode.

According to certain aspects of the present disclosure, when the wireless node (e.g., UE, CPE) is in connected/online mode, the ASDIV algorithm may check one or more additional conditions prior to granting/configuring a new ASDIV configuration.

In some aspects, the additional condition may be met if the candidate antenna pair combination meets an (e.g., configured) EVM threshold. After this condition is met, the wireless node may proceed to check other ASDIV switching criteria such as RSRP and UL power headroom. For example, in some aspects, if the ASDIV switching controller determines (e.g., based on the measurements) that there are problematic antenna combinations that fail to meet the EVM threshold, then the ASDIV controller excludes such combinations from the allowed antenna combinations list.

Consider an example scenario where an ASDIV switching capability for an RF band N41 has 4 antennas that can be switched to for UL-MIMO. For example, consider the following set of possible antenna pairs (Tx0, Tx1): {(1,2), (1,3), (1,4), (2,3), (2,4), (3,4)}. In some aspects, in such a scenario, if the EVM criteria/threshold/condition is not met for combination (1,3), then the set of allowed ASDIV switching combinations may be reduced to a subset of {(1,2), (1,4), (2,3), (2,4), (3,4)}.

While the relatively simple example above describes 4 antennas, a similar procedure may be applied for any given N-antenna capability for a corresponding RF band that UE supports UL-MIMO or UL-CA co-banded.

RF front-end isolation may be one of the main factors causing EVM degradation especially at high MCS (e.g., 256 Quadrature Amplitude Modulation (QAM)), which is typically used for UL throughput benchmarking with UL-MIMO NR. Aspects of the present disclosure provide techniques to characterize the EVM degradation, threshold the EVM measurements for all antenna/path combinations and determine a list of allowed antenna combinations that meets the EVM criteria. The techniques disclosed herein also enable automation of the EVM measurements in an FTM to determine the EVM a-priori in a factory setting and make use of such EVM measurements when UE or CPE is in online mode. As the number of possible antenna combinations increases, and as OEMs RF front-end design challenges increase (e.g., due to more complex and integrated industrial design for 5G UEs and CPEs), the value and advantages associated with the techniques proposed herein increase.

As noted above, EVM measurements may be obtained in a testing mode (e.g., FTM) to determine the EVM a-priori (e.g., in a factory setting) and make use of such EVM measurements when the UE or CPE is in online mode.

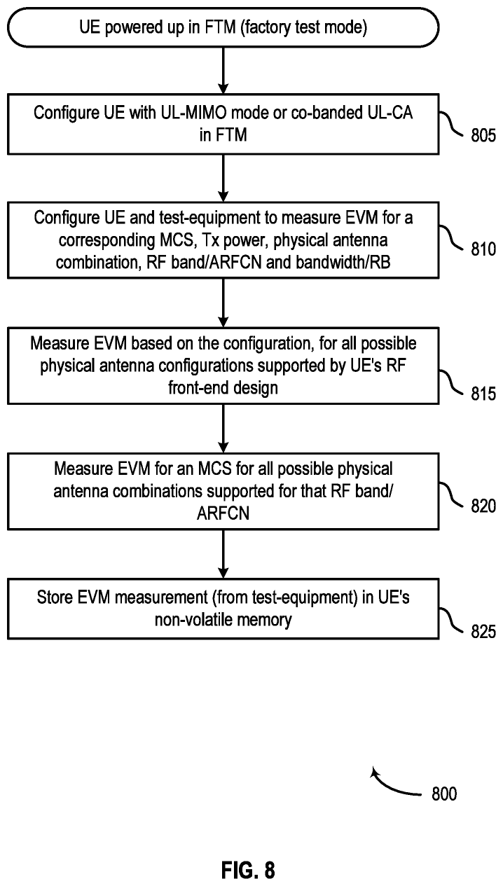

FIG. 8 depicts a flow diagram 800 illustrating techniques for a UE in a test mode, in accordance with certain aspects of the present disclosure. As illustrated, the UE may be powered up in an FTM.

As illustrated at 805, the UE may be configured with UL-MIMO mode or co-banded UL-CA (e.g. N41, N78 with Tx0, Tx1 same band) in FTM.

As illustrated at 810, the UE and test-equipment (e.g., a test-box) may be configured to measure EVM for a corresponding MCS, transmission power, physical antenna combination, RF band/ARFCN and bandwidth/RB (e.g. for peak throughput UL-MIMO EVM measured corresponding to 256 QAM for n41, N78).

As illustrated at 815, EVM may be measured based on the configuration, for all possible physical antenna configuration supported by UE's RF front-end design (e.g. a combination of UE's RF antenna switches, RF front-end and PCB traces/routes/paths, antenna tuner circuits for that RF band/ARFCN physical antenna, antenna switchable extractor settings (switchable extractor in extractor vs bypass mode)).

As illustrated at 820, EVM may be measured for an MCS for all possible physical antenna combinations supported for a given RF band/ARFCN. For example, in some aspects, N41 UL-MIMO may support transmissions on antennas 1,2,3,4. In such aspects, EVM may be measured on (Tx0, Tx1) physical antenna combinations of Ant(1,2), Ant (1,3), Ant (1,4), Ant (2,3), Ant (2,4), Ant (3,4).

As illustrated at 825, the EVM measurement may be retrieved from the test-equipment and stored in the wireless node's (e.g., the UE's/CPE's) non-volatile memory.

As noted above, according to certain aspects of the present disclosure, when the wireless node (e.g., UE, CPE) is in connected/online mode (after the FTM configuration described above with reference to FIG. 8), the ASDIV algorithm may check an additional condition prior to granting/configuring a new ASDIV configuration. For example, the additional condition may be met if the candidate antenna pair combination meets an (e.g., configured) EVM threshold.

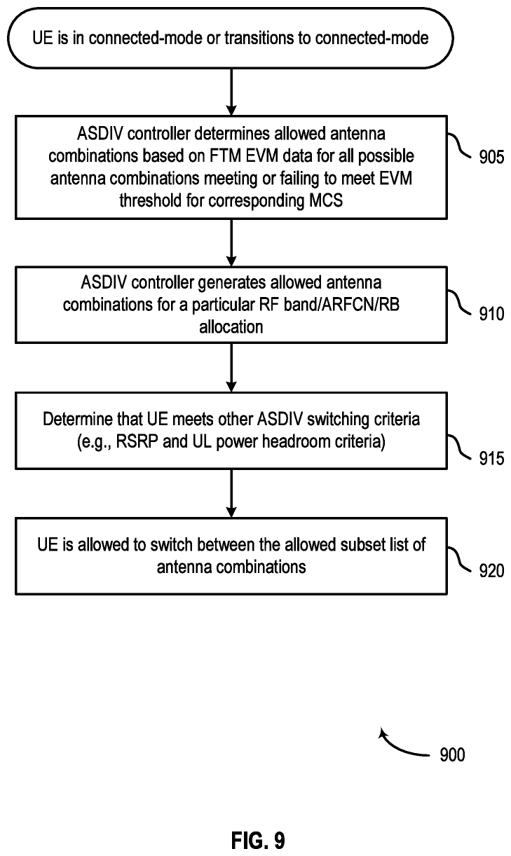

FIG. 9 depicts a flow diagram 900 illustrating these techniques for a UE in connected-mode, in accordance with certain aspects of the present disclosure. As illustrated, the UE may be in a connected-mode or may transition to a connected-mode (e.g., after FTM mode configuration).

As illustrated at 905, an ASDIV controller (e.g., of the wireless node/UE/CPE) may determine allowed antenna combinations, based on the FTM EVM metrics/data, for configured RF-band ARFCN/RB UL-MIMO or UL-CA co-banded for all possible antenna combinations meeting or failing to meet an EVM threshold for corresponding MCS.

As illustrated at 910, the ASDIV controller generates allowed Antenna combinations for a particular RF band/ARFCN/RB allocation. For example, consider an example scenario where the set of all possible antenna combination for N41 UL-MIMO is {(1,2) (1,3) (1,4) (2,3) (2,4) (3,4)}. In such a scenario, if antenna pair (1,3) was determined not to meet EVM threshold of 3.5 % for 256 QAM MCS (e.g., based on FTM EVM measurements), antenna pair (1,3) may be removed from the set of antenna combinations (e.g., creating an allowed antenna combinations set/subset). Hence, a modem (ASDIV controller) may generate the following allowed list of ASDIV antenna combinations: {(1,2) (1,4) (2,3), (2,4), (3,4)}.

As illustrated at 915, other ASDIV switching criteria may be evaluated (e.g., RSRP and UL power headroom criteria).

As illustrated at 920, once it has been determined that the UE meets the other ASDIV switching criteria, the UE may be allowed to switch between the allowed list of ASDIV antenna combinations.

### Example Operations

FIG. 10 shows an example of a method 1000 of wireless communication at a wireless node, such as a UE 104 of FIGS. 1 and 3.

Method 1000 begins at step 1005 with obtaining metrics for a set of candidate radio frequency (RF) path combinations to be considered for transmit antenna switch diversity (ASDIV). In some cases, the operations of this step refer to, or may be performed by, circuitry for obtaining and/or code for obtaining as described with reference to FIG. 11.

Method 1000 then proceeds to step 1010 with removing at least a first RF path combination from the set when a condition involving at least one of the metrics is met. In some cases, the operations of this step refer to, or may be performed by, circuitry for removing and/or code for removing as described with reference to FIG. 11.

In some aspects, each candidate RF path combination of the set corresponds to at least two antennas.

In some aspects, the metrics are obtained for RF path combinations corresponding to an RF band that the wireless node supports for at least one of uplink (UL) multiple-input multiple-output (MIMO) or co-banded UL carrier aggregation (CA).

In some aspects, the method 1000 further includes selecting a second RF path combination from the set after removing the first RF path combination. In some cases, the operations of this step refer to, or may be performed by, circuitry for selecting and/or code for selecting as described with reference to FIG. 11.

In some aspects, the metrics comprise error vector magnitude (EVM) metrics measured for the set of candidate RF path combinations.

In some aspects, the condition is met when the EVM metric measured for the first RF path combination exceeds an EVM threshold.

In some aspects, the metrics comprise EVM metrics measured for the set, for a configured transmission characteristic.

In some aspects, the configured transmission characteristic comprises a configured modulation and coding scheme (MCS) value.

In some aspects, the EVM metrics are measured while the wireless node is in a test mode and stored in memory at the wireless node.

In some aspects, obtaining the metrics comprises retrieving the metrics from memory.

In one aspect, method 1000, or any aspect related to it, may be performed by an apparatus, such as communications device 1100 of FIG. 11, which includes various components operable, configured, or adapted to perform the method 1000. Communications device 1100 is described below in further detail.

Note that FIG. 10 is just one example of a method, and other methods including fewer, additional, or alternative steps are possible consistent with this disclosure.

### Example Communications Device(s)

FIG. 11 depicts aspects of an example communications device 1100. In some aspects, communications device 1100 is a user equipment, such as UE 104 described above with respect to FIGS. 1 and 3.

The communications device 1100 includes a processing system 1105 coupled to the transceiver 1155 (e.g., a transmitter and/or a receiver). The transceiver 1155 is configured to transmit and receive signals for the communications device 1100 via the antenna 1160, such as the various signals as described herein. The processing system 1105 may be configured to perform processing functions for the communications device 1100, including processing signals received and/or to be transmitted by the communications device 1100.

The processing system 1105 includes one or more processors 1110. In various aspects, the one or more processors 1110 may be representative of one or more of receive processor 358, transmit processor 364, TX MIMO processor 366, and/or controller/processor 380, as described with respect to FIG. 3. The one or more processors 1110 are coupled to a computer-readable medium/memory 1130 via a bus 1150. In certain aspects, the computer-readable medium/memory 1130 is configured to store instructions (e.g., computer-executable code) that when executed by the one or more processors 1110, cause the one or more processors 1110 to perform the method 1000 described with respect to FIG. 10, or any aspect related to it. Note that reference to a processor performing a function of communications device 1100 may include one or more processors 1110 performing that function of communications device 1100.

In the depicted example, computer-readable medium/memory 1130 stores code (e.g., executable instructions), such as code for obtaining 1135, code for removing 1140, and code for selecting 1145. Processing of the code for obtaining 1135, code for removing 1140, and code for selecting 1145 may cause the communications device 1100 to perform the method 1000 described with respect to FIG. 10, or any aspect related to it.

The one or more processors 1110 include circuitry configured to implement (e.g., execute) the code stored in the computer-readable medium/memory 1130, including circuitry such as circuitry for obtaining 1115, circuitry for removing 1120, and circuitry for selecting 1125. Processing with circuitry for obtaining 1115, circuitry for removing 1120, and circuitry for selecting 1125 may cause the communications device 1100 to perform the method 1000 described with respect to FIG. 10, or any aspect related to it.

Various components of the communications device 1100 may provide means for performing the method 1000 described with respect to FIG. 10, or any aspect related to it. For example, means for transmitting, sending or outputting for transmission may include transceivers 354 and/or antenna(s) 352 of the UE 104 illustrated in FIG. 3 and/or the transceiver 1155 and the antenna 1160 of the communications device 1100 in FIG. 11. Means for receiving or obtaining may include transceivers 354 and/or antenna(s) 352 of the UE 104 illustrated in FIG. 3 and/or the transceiver 1155 and the antenna 1160 of the communications device 1100 in FIG. 11.

### EXAMPLE CLAUSES

Implementation examples are described in the following numbered clauses:
Clause 1: A method for wireless communication at a wireless node, comprising: obtaining metrics for a set of candidate radio frequency (RF) path combinations to be considered for transmit antenna switch diversity (ASDIV); and removing at least a first RF path combination from the set when a condition involving at least one of the metrics is met.
Clause 2: The method of Clause 1, wherein each candidate RF path combination of the set corresponds to at least two antennas.
Clause 3: The method of any one of Clauses 1-2, wherein the metrics are obtained for RF path combinations corresponding to an RF band that the wireless node supports for at least one of uplink (UL) multiple-input multiple-output (MIMO) or co-banded UL carrier aggregation (CA).
Clause 4: The method of any one of Clauses 1-3, further comprising selecting a second RF path combination from the set after removing the first RF path combination.
Clause 5: The method of any one of Clauses 1-4, wherein the metrics comprise error vector magnitude (EVM) metrics measured for the set of candidate RF path combinations.
Clause 6: The method of Clause 5, wherein: the condition is met when the EVM metric measured for the first RF path combination exceeds an EVM threshold.
Clause 7: The method of Clause 5, wherein the metrics comprise EVM metrics measured for the set, for a configured transmission characteristic.
Clause 8: The method of Clause 7, wherein the configured transmission characteristic comprises a configured modulation and coding scheme (MCS) value.
Clause 9: The method of Clause 5, wherein the EVM metrics are measured while the wireless node is in a test mode and stored in memory at the wireless node.
Clause 10: The method of Clause 9, wherein obtaining the metrics comprises retrieving the metrics from memory.
Clause 11: An apparatus, comprising: a memory comprising executable instructions; and a processor configured to execute the executable instructions and cause the apparatus to perform a method in accordance with any one of Clauses 1-10.
Clause 12: An apparatus, comprising means for performing a method in accordance with any one of Clauses 1-10.
Clause 13: A non-transitory computer-readable medium comprising executable instructions that, when executed by a processor of an apparatus, cause the apparatus to perform a method in accordance with any one of Clauses 1-10.
Clause 14: A computer program product embodied on a computer-readable storage medium comprising code for performing a method in accordance with any one of Clauses 1-10.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus for wireless communications at wireless node, comprising:
a processor;
memory coupled with the processor; and
instructions stored in the memory and executable by the processor to cause the apparatus to
obtain metrics for a set of candidate radio frequency (RF) path combinations to be considered for transmit antenna switch diversity (ASDIV); and
remove at least a first RF path combination from the set when a condition involving at least one of the metrics is met.

2. The apparatus of claim 1, wherein each candidate RF path combination of the set corresponds to at least two antennas.

3. The apparatus of claim 1, wherein the metrics are obtained for RF path combinations corresponding to an RF band that the wireless node supports for at least one of uplink (UL) multiple-input multiple-output (MIMO) or co-banded UL carrier aggregation (CA).

4. The apparatus of claim 1, wherein the instructions stored in the memory are further executable by the processor to cause the apparatus to:
select a second RF path combination from the set after removing the first RF path combination.

5. The apparatus of claim 1, wherein the metrics comprise error vector magnitude (EVM) metrics measured for the set of candidate RF path combinations.

6. The apparatus of claim 5, wherein: the condition is met when the EVM metric measured for the first RF path combination exceeds an EVM threshold.

7. The apparatus of claim 5, wherein the metrics comprise EVM metrics measured for the set, for a configured transmission characteristic.

8. The apparatus of claim 7, wherein the configured transmission characteristic comprises a configured modulation and coding scheme (MCS) value.

9. The apparatus of claim 5, wherein the EVM metrics are measured while the wireless node is in a test mode and stored in memory at the wireless node.

10. The apparatus of claim 9, wherein obtaining the metrics comprises retrieving the metrics from memory.

11. A method for wireless communication at a wireless node, comprising:
obtaining metrics for a set of candidate radio frequency (RF) path combinations to be considered for transmit antenna switch diversity (ASDIV); and
removing at least a first RF path combination from the set when a condition involving at least one of the metrics is met.

12. The method of claim 11, wherein each candidate RF path combination of the set corresponds to at least two antennas.

13. The method of claim 11, wherein the metrics are obtained for RF path combinations corresponding to an RF band that the wireless node supports for at least one of uplink (UL) multiple-input multiple-output (MIMO) or co-banded UL carrier aggregation (CA).

14. The method of claim 11, further comprising:
selecting a second RF path combination from the set after removing the first RF path combination.

15. The method of claim 11, wherein the metrics comprise error vector magnitude (EVM) metrics measured for the set of candidate RF path combinations.

16. The method of claim 15, wherein: the condition is met when the EVM metric measured for the first RF path combination exceeds an EVM threshold.

17. The method of claim 15, wherein the metrics comprise EVM metrics measured for the set, for a configured transmission characteristic.

18. The method of claim 17, wherein the configured transmission characteristic comprises a configured modulation and coding scheme (MCS) value.

19. The method of claim 15, wherein the EVM metrics are measured while the wireless node is in a test mode and stored in memory at the wireless node.

20. (canceled)

21. An apparatus for wireless communication at a wireless node, comprising:
means for obtaining metrics for a set of candidate radio frequency (RF) path combinations to be considered for transmit antenna switch diversity (ASDIV); and
means for removing at least a first RF path combination from the set when a condition involving at least one of the metrics is met.
